(19) United States
(12) Patent Application Publication
(10) Pub. No.: US 2008/0277329 A1
(43) Pub. Date: Nov. 13, 2008

(54) Jet Nozzle Arrangement for Optimising Gas Bubble Size in Flotation

(76) Inventors: Yanmin Zhang, Leeds (GB); Stuart B. Dalziel, Cambridge (GB); David Leppinen, Staffordshire (GB)

Correspondence Address: FAY SHARPE LLP, 1100 SUPERIOR AVENUE, SEVENTH FLOOR, CLEVELAND, OH, 44114, US

(21) Appl. No.: 11/885,726

(22) PCT Filed: Mar. 2, 2006
(86) PCT No.: PCT/GB2006/000730

§ 371 Date: Jun. 4, 2008

(30) Foreign Application Priority Data
Mar. 3, 2005 (GB) 0504404.5

(51) Int. Cl. B03D 1/24; B01F 5/04; B01F 3/08; C02F 1/24; B01F 3/04

(52) U.S. Cl. 210/220

(57) ABSTRACT

The present invention provides a nozzle assembly for use in a dissolved gas flotation system, comprising: a nozzle having at least one inlet and at least one outlet, the at least one inlet and the at least one outlet being in fluid communication; and a shroud comprising a first shroud portion, the shroud being arranged, in use, to at least partly receive and confine a gas saturated fluid stream emitted from at least one nozzle outlet; the nozzle assembly being arrangeable in use within an ambient fluid, such that the gas saturated fluid stream forms bubbles within the ambient fluid; characterised by: the shroud comprising at least one aperture for, in use, allowing the ambient fluid to communicate with an interior of the shroud.

The present invention relates to a nozzle and a nozzle assembly for a dissolved gas flotation system, and in particular, although not exclusively, a dissolved air flotation system.

Dissolved air flotation (DAF) is a gravity assisted separation process in which microbubbles are used to remove suspended solid particles from a liquid. Solid suspended particles, or suspended solid articles, are typically referred to as floc particles.

In a DAF process, floc particles are removed from a liquid held in a flotation tank by means of forming bubble and floc agglomerates within the liquid, which rise to the top of the flotation tank. To achieve the formation of bubble-floc agglomerates, the particle-laden liquid is slowly moved through the flotation tank into which is mixed an aerated recycle stream. The recycle stream is saturated with air at high pressure in order to generate microbubbles within the liquid held in the flotation tank. A proportion of the microbubbles in the flotation tank form bubble-floc agglomerates, which, when sufficiently buoyant, rise to the top of the flotation tank. At a top of the tank, a sludge-blanket is formed, which can be removed by either draining liquid from the top of the tank by means of a weir, or by means of a scraper. An exit flow of particle-reduced liquid is removed from a lower area of the flotation tank.

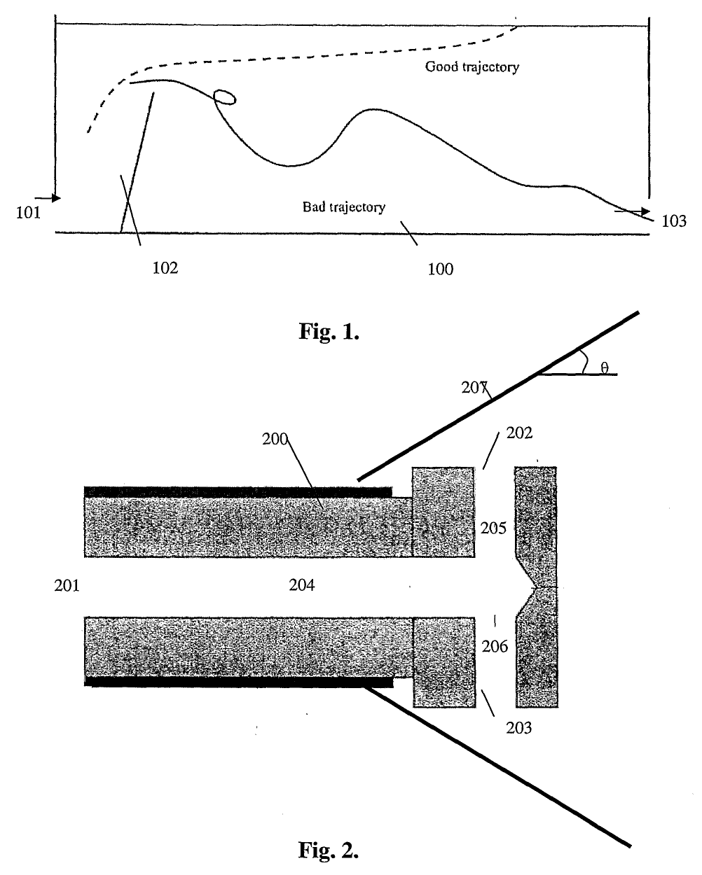

FIG. 1 shows a schematic of a flotation tank 100 used in water treatment. Particle laden water enters the tank via a tank inlet 101 and mixes with the entering recycle stream (not shown) in a contact zone of the tank, toward the left hand side tank inlet 101. An upward ramp 102 is provided at the bottom of the tank 100 to direct the incoming water upward, aiding particle flotation. Bubbles formed from the recycle stream attach to floc particles in the flotation tank 100, thereby forming bubble-floc agglomerates. After exiting the contact zone, the agglomerates enter a flotation zone toward the centre of the tank 100, wherein sufficiently buoyant agglomerates having a good trajectory rise to form a sludge blanket. Unsuccessfully buoyant agglomerates have a generally downward, unsuccessful trajectory, toward a tank outlet 103 and are removed with the outward flow of water. The upward ramp 102 or baffle is provided between the contact and flotation zones to direct agglomerates upward, away from the exit flow 103. FIG. 1 shows a dashed curve representing the path of a successful agglomerate flotation and a solid line representing unsuccessful flotation.

It can be understood from the above description that the formation of sufficiently buoyant agglomerates is of prime importance in DAF processing.

In a DAF system involving the removal of particles from water, and in particular although not exclusively, drinking water using a water recycle stream saturated with air, water is saturated with air at around 5 bar pressure, typically in a saturation tank (not shown). The saturated water is then passed into the floatation tank through a pressure-reducing nozzle, which is located at a lower region of the flotation tank 100 near the inlet 101. The recycle stream water becomes super-saturated and air is released from the recycle stream entering the flotation tank 100 in the form of bubbles.

A longitudinal cross section through a prior art pressure reduction nozzle 200 is shown in FIG. 2. The prior art pressure reduction nozzle is T-shaped and features an inlet port 201 and a pair of outlet ports 202, 203 through which the saturated water enters the flotation tank 100. The inlet port 201 communicates with an inlet channel 204, which runs axially along the substantial length of the nozzle 200 body, before splitting, at a head end of the nozzle, into first 205 and second 206 outlet channels. The inlet channel 204 is of uniform diameter along its length, with the outlet channels 205, 206 being of a smaller diameter than the inlet channel. The total cross section of the first and second outlet channels 205, 206 equals that of the inlet channel 204. An external surface of the nozzle 200 is threaded to allow the nozzle 200 to be screwed into a threaded coupling of a pipe. To fluid entering the nozzle from a supply, the nozzle 200 acts as a constriction region since, typically in laboratory experiments, 8 mm internal diameter tubing is used to connect the saturation tank to the nozzle 200, whilst an internal diameter of the nozzle is 3.8 mm. In practical applications, the nozzle may connect to a much larger supply pipe or line, however, the nozzle still presents a constriction to the recycle stream.

A conical shroud 207, having a divergence angle θ of between 30° and 40° from the longitudinal axis of the nozzle, surrounds the head end of the nozzle 200. The conical shroud 207 is used to direct the flow of saturated water and bubbles into the flotation tank 100.

It is an aim of the present invention to provide a more efficient DAF system and an improved pressure reduction nozzle suitable for use with a DAF system, which promotes the formation of bubble-floc agglomerates.

It is an aim of the present invention to provide an improved pressure reduction nozzle, which allows the air saturation pressure to be reduced, thereby saving energy in a DAF process. Additionally, the efficiency of floc removal is increased.

According to the present invention there is provided an apparatus and method as set forth in the appended claims. Preferred features of the invention will be apparent from the dependent claims, and the description which follows.

According to a first aspect of the present invention there is provided a nozzle assembly for use in a dissolved gas flotation system, comprising: a nozzle having at least one inlet and at least one outlet, the at least one inlet and the at least one outlet being in fluid communication; and a shroud comprising a first shroud portion, the shroud being arranged, in use, to at least partly receive and confine a gas saturated fluid stream emitted from at least one nozzle outlet; the nozzle assembly being arrangeable in use within an ambient fluid, such that the gas saturated fluid stream forms bubbles within the ambient fluid; characterised by: the shroud comprising at least one aperture for, in use, allowing the ambient fluid to communicate with an interior of the shroud.

Preferably, the at least one aperture is in a wall of the shroud.

Preferably, the first shroud portion controls a size of bubbles formed in the ambient fluid.

Preferably, shroud has substantially parallel sides.

Preferably, the first shroud portion has substantially parallel sides.

The first shroud portion may be generally convergent.

Preferably, the shroud comprises at least one shroud inlet for receiving the fluid stream emitted from at least one nozzle outlet.

Preferably, the at least one shroud inlet is arranged at an end region of the shroud proximal to the at least one nozzle outlet.

Preferably, the shroud comprises at least one shroud outlet for allowing a received fluid stream to communicate an exterior of the shroud.

Preferably, at least one shroud outlet is arranged at an end region of the shroud distal from the outlet.

Preferably, shroud comprises one shroud inlet.

Preferably, the shroud inlet is arranged at an end of the first shroud portion.

Preferably, the shroud comprises one shroud outlet.

Preferably, the shroud may be longitudinally separated from the nozzle.

Preferably, the at least one shroud inlet is arranged to receive substantially all of the fluid stream emitted from the nozzle outlet.

Preferably, substantially all fluid emitted from the nozzle outlet is communicated to an interior of the shroud.

Preferably, the at least one nozzle outlet communicates with a substantially enclosed first end of the shroud.

Preferably, the shroud may be generally cylindrical.

Preferably, the first shroud portion may be generally cylindrical.

Preferably, the shroud may have a substantially continuous circular cross section.

Preferably, the first shroud portion has a substantially continuous circular cross section.

Preferably, the at least one nozzle outlet communicates with a first end of the first shroud portion.

Preferably, the nozzle comprises at least one channel disposed between the at least one inlet and the at least one outlet.

Preferably, the at least one channel is the constriction between the at least one inlet and the at least one outlet.

The constriction may have the minimum width d.

The constriction may have the minimum diameter d.

The constriction may have a width of between 2 and 4 mm.

The constriction may have a width of between 2.45 and 3.2 mm.

The constriction may have a width of approximately 2.8 mm.

The constriction may have a diameter of approximately 2.8 mm.

Preferably, the constriction has a cross section of between 3.1 mm² and 50 mm².

Preferably, the constriction has a cross sectional area of approximately 6 mm².

A cross sectional area of the at least one nozzle inlet may be greater than a cross sectional area of the constriction.

A cross sectional area of the at least one outlet may be greater than a cross sectional area of the constriction.

Preferably, the nozzle comprises at least one convergence region at an inlet end of the nozzle.

Preferably, the at least one convergence region is formed internally within the nozzle.

The convergence region may converge inward from the nozzle inlet.

Preferably, the nozzle comprises at least one divergence region at the outlet end of the nozzle.

Preferably, the at least one divergence region is formed internally within the nozzle.

Preferably, the divergence region diverges outward toward the nozzle outlet.

The nozzle may be generally circular in cross section.

The at least one inlet may be located within a first end of the nozzle.

Preferably, the at least one outlet is located within a second end of the nozzle.

Preferably, the channel is generally axially oriented through the nozzle.

Preferably, the nozzle comprises one inlet.

Preferably, the nozzle comprises one outlet.

The inlet, the outlet and the channel may be generally concentric.

An outer surface of the nozzle may be adapted to cooperate with a fluid delivery pipe.

An outer surface of the nozzle may be threaded.

At least part of the fluid communicated to the first shroud portion may be communicated to the second shroud portion.

Substantially all the fluid communicated to the first shroud portion may be communicated to the second shroud portion.

Preferably, the shroud comprises at least one aperture at an intermediate region of the shroud.

The at least one aperture may be arranged, in use, to allow ambient fluid to enter the shroud.

Preferably, the shroud comprises a plurality of openings at an intermediate region thereof, arranged, in use, to allow ambient fluid to enter the shroud.

Preferably, the second shroud portion has a general divergence of less than 30 degrees.

The second shroud portion may have a general divergence of less than 20 degrees.

The second shroud portion may have a general divergence of less than 10 degrees.

The second shroud portion may have a general divergence of less than 5 degrees.

The second shroud portion may have a generally circular cross section.

The second shroud portion may be generally cylindrical.

The second shroud portion may have substantially parallel sides.

The second shroud portion may have a greater diameter than the first shroud portion.

According to a second aspect of the invention there is provided a dissolved gas flotation system comprising at least one nozzle assembly as defined in the claims as appended hereto arranged to receive, in use, a gas saturated fluid stream; a tank for containing an ambient fluid; wherein the at least one nozzle assembly is arranged within the tank such that the gas saturated fluid stream forms bubbles within the ambient fluid generally having a median size of 50 μm or less.

According to a further aspect of the invention there is provided a nozzle assembly for use in a dissolved gas flotation system, comprising: a nozzle having at least one inlet and at least one outlet, the at least one inlet and the at least one outlet being in fluid communication; and a shroud comprising a first shroud portion, the shroud being arranged, in use, to at least partly receive and confine a gas saturated fluid stream emitted from at least one nozzle outlet; the nozzle assembly being arrangeable in use within an ambient fluid, such that the gas saturated fluid stream forms bubbles within the ambient fluid generally having a median size of 50 μm or less.

For a better understanding of the invention, and to show how embodiments of the same may be carried into effect, reference will now be made, by way of example, to the accompanying diagrammatic drawings in which:

FIG. 1 is a side cross-sectional schematic view of a flotation tank;

FIG. 2 is a longitudinal cross sectional view through a prior art pressure reduction nozzle;

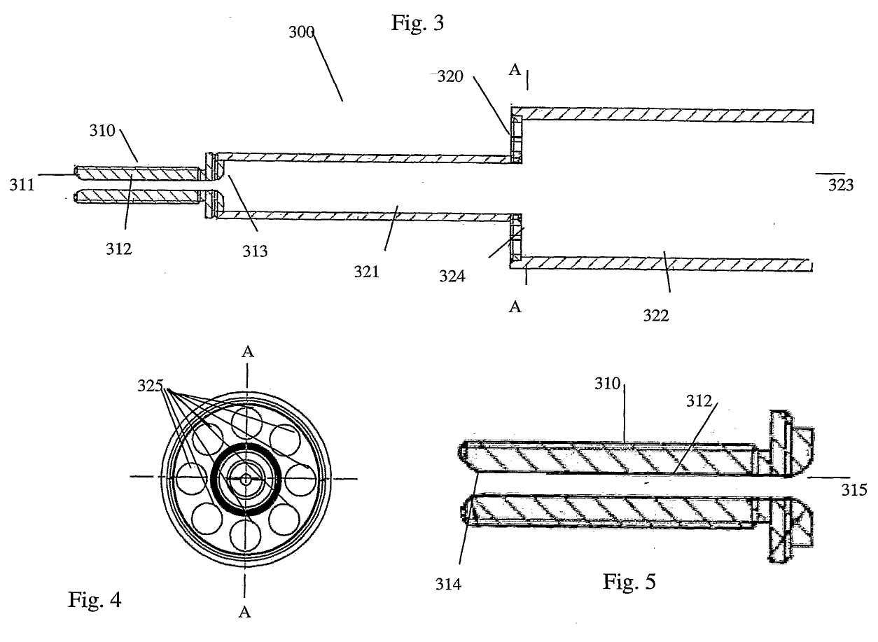

FIG. 3 is a side cross sectional view through a preferred embodiment of a pressure reduction nozzle according to the invention;

FIG. 4 is a cross section through a line A-A shown in FIG. 3;

FIG. 5 is a longitudinal cross section through a nozzle of the preferred embodiment;

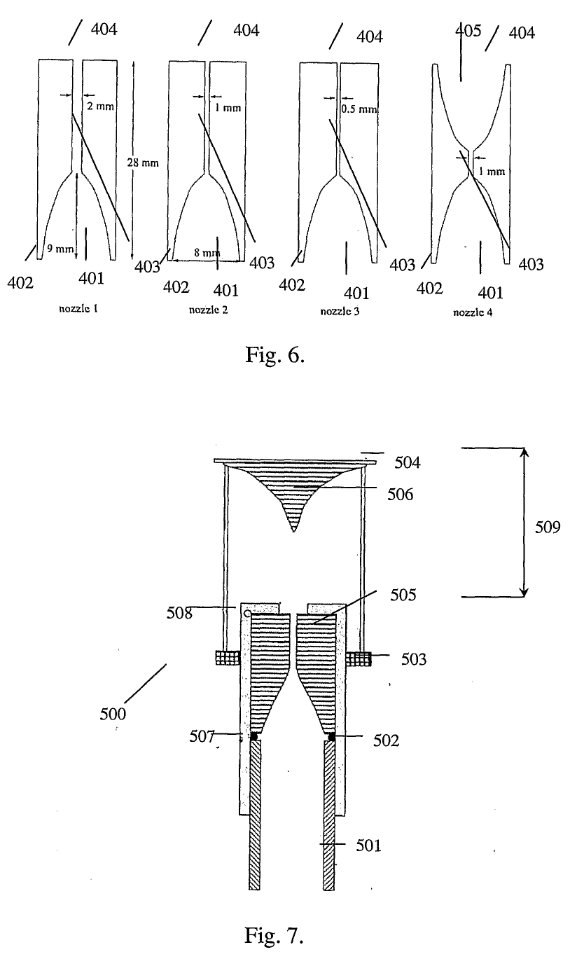

FIG. 6 is a cross sectional view through four different pressure reduction nozzles tested;

FIG. 7 is a cross sectional schematic view through an experimental pressure reduction nozzle set-up;

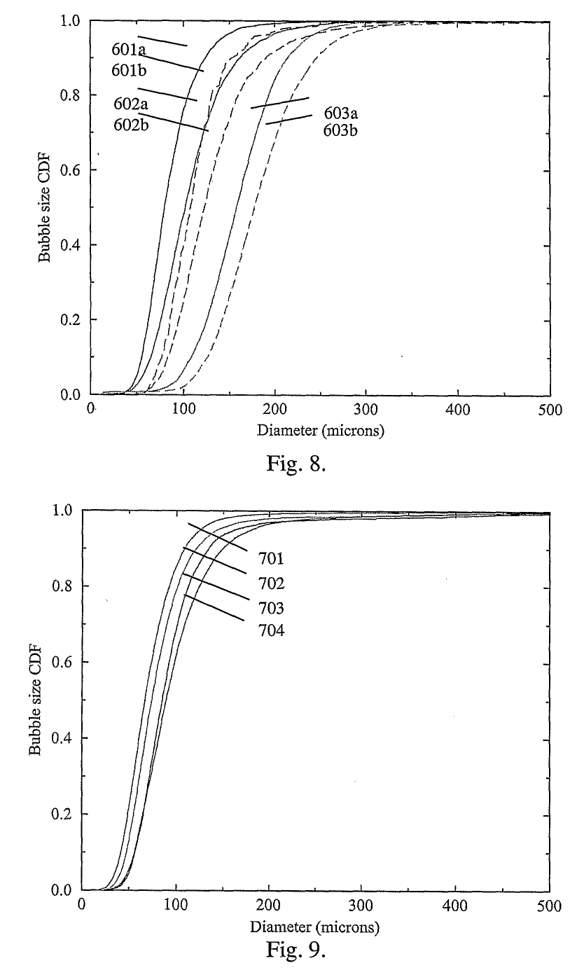

FIG. 8 is a plot of six cumulative bubble size distribution functions for nozzles 1 to 3 at two different shield heights;

FIG. 9 is plot of four cumulative bubble size distribution functions as a function of shield height for nozzle 4;

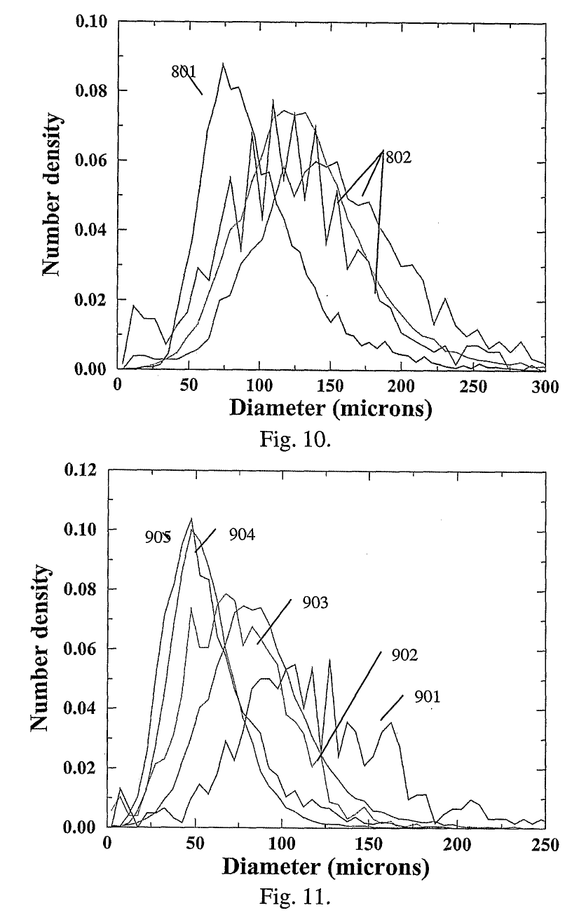

FIG. 10 is a plot of bubble fraction for an unconfined nozzle compared to a confined nozzle;

FIG. 11 is a plot of bubble fraction as a function of gap height between a shroud and a nozzle outlet for five different gap heights;

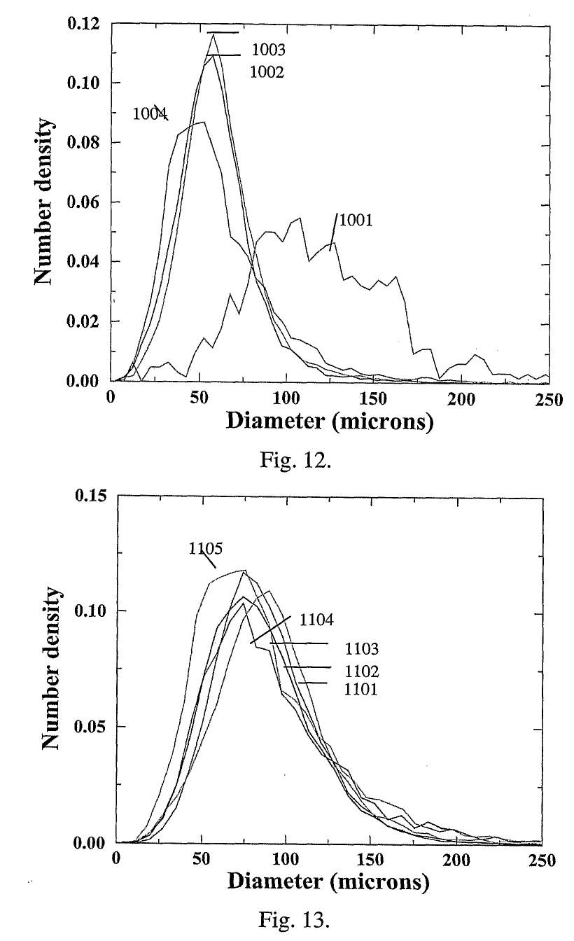

FIG. 12 is a plot of bubble fraction as a function of shroud height for four different shroud heights;

FIG. 13 is a plot of bubble fraction using a conical shroud for five different conical shrouds;

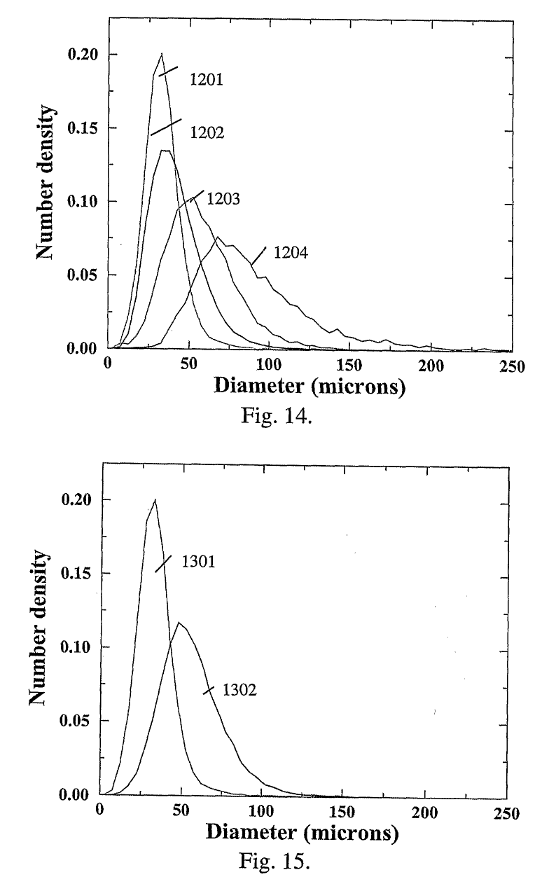

FIG. 14 is a plot of bubble fraction using a single shroud portion of three different diameters compared to using no shroud;

FIG. 15 is a plot of bubble fraction for two different first shroud portion diameters; and

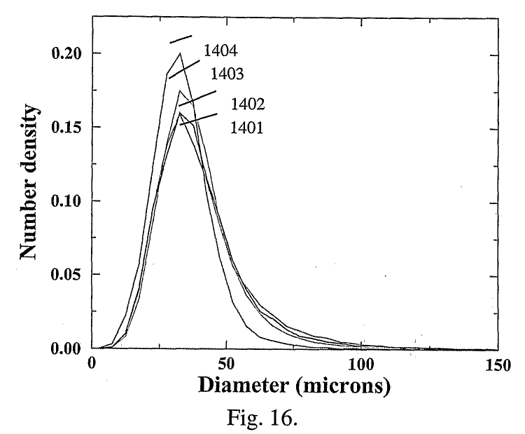

FIG. 16 is a plot of bubble fraction for different second shroud portion diameters;

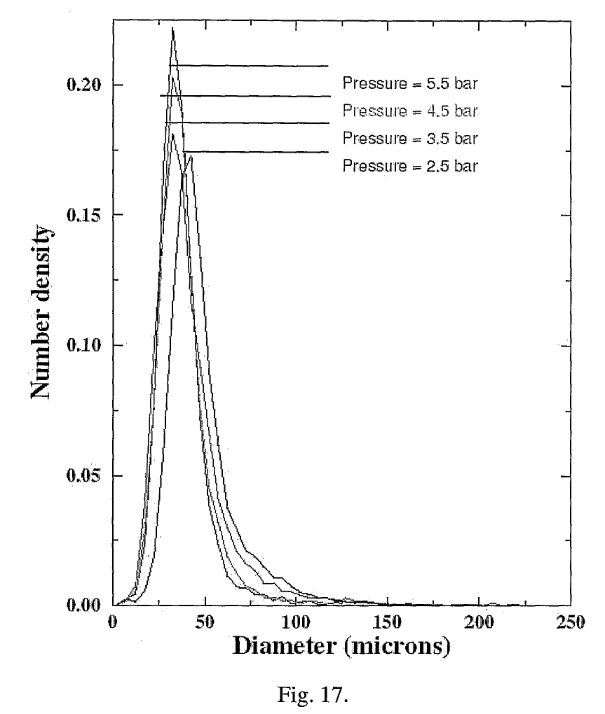

FIG. 17 is a plot of bubble fraction for the preferred embodiment of the present invention at four different operating pressures.

Recently, research by the present inventors has indicated that bubbles formed in a flotation tank cluster together into large groups, with floc particles clumped between the bubbles. The buoyancy of the cluster as a whole ensures that the cluster will have a much greater rise velocity than an individual bubble. It is believed that as clusters rise, they act as a net collecting other smaller clusters and/or further floc particles.

From this research, it has been deduced that the size of bubbles produced within a flotation tank has a strong influence on the effectiveness or efficiency of a DAF process. It is believed that smaller bubbles are more effective at creating bubble-floc agglomerates. Further, it is believed that hydrodynamic forces, such as a velocity sheer force, which act on a larger bubble to separate bubble-floc agglomerates are proportionally greater than for a smaller bubble due to the increased surface area of the relatively larger bubble.

Measurement of a bubble size (diameter) distribution within the flotation tank can be made by drawing liquid from the flotation tank upward through a transparent tube, made from, for example, Perspex™. A pump is used to draw liquid upward through the tube, whilst a high-resolution digital video camera, for example a JAI CV/M4-CL fitted with a 0.75× to 4.5× macro lens, records the liquid flow through the tube, which is back-lit to aid image recording. At maximum magnification this camera has a resolution of 1.4 by 1.4 μm. Bubble size can then be measured from the resultant digital images, preferably using measurement of 2000 bubbles to produce a reliable sample.

Measurements have shown that in a prior-art DAF system, bubbles are formed having a median diameter in the contact zone of the flotation tank 100 of between 70 and 84 μm.

This research has also indicated that macrobubble formation within the flotation tank 100 significantly reduces the effectiveness of the DAF process. A macrobubble is a bubble having a diameter of 1 mm or greater. It is believed that macrobubbles are disadvantageous due to the aforementioned problems with being incorporated into bubble clusters. Further, the associated cost of macrobubble formation can be significant, since a 1 mm macrobubble contains the equivalent amount of air as one thousand 100 μm bubbles.

It has also been deduced that a significant fragmentation of bubble clusters can occur when bubbly water is mixed with floc-laden water. To reduce this fragmentation, the hydrodynamic forces acting upon a bubble cluster should be reduced in order to allow larger bubble clusters to grow. In particular, the shear force between a bubbly recycle stream and the water contained in the flotation tank 100 should be reduced so as to allow large bubble-cluster formation.

As shown in FIG. 3, the preferred embodiment 300 of the nozzle assembly comprises a nozzle 310 and a shroud 320.

The nozzle 310 is cylindrically shaped, having a circular cross-section, and has an inlet 311 in a face of a first end of the nozzle 310. Fluid enters the nozzle 310 by means of the inlet 311. The inlet 311 communicates with a channel 312 running axially through the nozzle 310. At a second end of the nozzle 310, the channel 312 communicates with an outlet 313. The outlet 313 is located in a face of a second end of the nozzle 310. The inlet 311, channel 312 and outlet 313 are, in the preferred embodiment, all concentric with respect to the longitudinal axis of the nozzle 310.

In this sense, the nozzle 310 is taken to mean the part of the assembly generally presenting a constriction to a fluid flow. In addition, in the preferred embodiment, the nozzle mechanically connects to a fluid delivery pipe. To aid connection to the fluid delivery pipe the outer surface of the nozzle 310 is threaded to allow the nozzle to be screwed into a corresponding threaded aperture in the fluid delivery pipe.

The preferred embodiment of the shroud 320 comprises a first shroud portion 321 and a second shroud portion 322. As can be seen from FIG. 3, the first shroud portion 321 is proximal to the nozzle outlet and has a smaller diameter than the second shroud portion 322.

The outlet 313 of the nozzle 310 is, in use, in fluid communication with the shroud 320. A fluid jet or stream emitted from the nozzle is completely transmitted to an interior of the first shroud portion 321. To the fluid stream emerging from the nozzle outlet 313, the first shroud provides a sudden expansion of the flow, whilst containing the expanded flow downstream.

The nozzle outlet 313 communicates with an enclosed first end of the first shroud portion 321, proximal to the nozzle outlet 313. The second end of the first shroud portion 321, distal from the nozzle outlet 313, communicates with a first end of the second shroud portion 322, whilst the second end of the second shroud portion 322 provides an outlet of the shroud 323.

In the preferred embodiment; the first 321 and second 322 shroud portions are cylindrical and are concentric with respect to the nozzle 310. The second end of the first shroud portion 321 distal from the nozzle 310 and the first end of the second shroud portion 322 proximal to the nozzle 310 are in longitudinal alignment, with the first 321 and second 322 shroud portions extending opposing directions.

The first end of the second shroud portion 322 comprises a radial, inwardly extending face 324, which partially encloses the first end of the second shroud portion 322 such than an ambient fluid around the nozzle assembly can flow into the shroud 320 at an intermediate region with a limited rate of flow. Since the first end of the first shroud portion 321 is enclosed, ambient fluid is prevented from entering the nozzle assembly close to the outlet 313. The face 324 is perpendicular to the longitudinal axis of the assembly. A cross section along the line A-A in FIG. 3 is shown in FIG. 4.

Unlike the first end of the first shroud portion 321, which is enclosed around the nozzle outlet 313, a plurality of openings 325 provided in the face 324 which, in use, allow the ambient fluid around the shroud 320 to enter the shroud at a mid-region thereof. In the preferred embodiment the openings are circular, however, it will be realised that any shape or size openings may be used. It will be realised that whilst the preferred embodiment shown has 8 openings 325, the size, shape, and number of these openings may be changed. Moreover, the location of these openings 325 may be changed. For example, the openings may be provided about the first shroud portion 321 or the second shroud portion 322. The location of the opening defines the junction between the first and second shroud portions in the preferred embodiment. The purpose of the first shroud portion 321 is to limit or reduce the size of bubbles formed from the nozzle assembly, whilst the second shroud portion 322 reduces a velocity shear between the recycle stream and the ambient fluid, such that large bubble-floc agglomerates are formed.

Referring to FIG. 5, the nozzle 310 comprises an inwardly diverging internal convergence region 314 at the inlet 311 end of a channel or constriction 312 and an outwardly diverging internal divergence region 315 at the outlet end 313 of the channel 312. An external surface of the nozzle 310 comprises a thread for engaging with a corresponding threaded aperture provided in the end of a pipe for supplying fluid to the nozzle 310.

Experiments were performed to examine the effect of different nozzle assembly arrangements upon a size distribution of bubbles generated from the nozzle assembly.

Four different nozzles were tested, as shown in FIG. 6. Nozzles 1-3 have an inwardly tapering internal convergence region 401 present at an inlet 402 end of each nozzle. Like parts of each nozzle have the same reference numerals.

In the experimental set-up the convergence region 401 has a length of 9 mm and a width of 8 mm at the inlet 402 end of the nozzle. In nozzles 1-3, the convergence region 401 leads into a channel or constriction 403, then to an outlet 404. The width of the channel 403 in each of nozzles 1-3 was varied, being 2 mm, 1 mm and 0.5 mm respectively. Nozzle 4 has an inwardly tapering convergence region 401 at the inlet 402 end of the nozzle, a 1 mm channel 403 and an internal divergence region 405 at the outlet 404 end of the channel 403. The divergence region 405 is symmetrical with respect to the convergence region 401. Each of the nozzles 1-4 was constructed from Delrin™ and was mounted, in an experimental set up, into a stainless steel nozzle holder, as shown in FIG. 7.

In FIG. 7, 501 is a stainless steel tube connected to a supply line from a saturation tank; 502 is a stainless steel collar to keep the Delrin nozzle in place; 503 is a height adjustable stainless steel collar holding a stainless steel impingement plate; 504 is a stainless steel impingement plate; 505 is the pressure reducing delrin nozzle; 506 is a Delrin cone mounted on the impingement plate to smoothly turn a jet exiting the nozzle; 507 is an o-ring; and 508 is a further o-ring.

In some experiments using the set up shown in FIG. 7, a Delrin cone was mounted on the stainless steel impingement plate 504 to smoothly turn the jet exiting from the nozzle. The nozzles tested were all axisymmetric, as shown in FIG. 6.

FIG. 8 presents the bubble size cumulative distribution functions (CDF) for nozzles 1 to 3 at two separate shield heights. 601 are the plots for nozzle 1, with 610a being at a shield height of 4.6 mm and 601b being at a shield height of 8.5 mm. 602 are the plots for nozzle 2, with 602a and 602b being at shields heights of 4.6 mm and 8.5 mm respectively, whilst 603 are the plots for nozzle 3 at shield heights of 4.6 mm 603a and 8.5 mm 603b respectively. The shield height is identified in FIG. 7 with reference numeral 509.

The results in FIG. 8 indicate a reduction of bubble size as the diameter of the nozzle constriction increases, and an increase in the bubble size as the height of the shield above the nozzle exit increases. For a shield height of 4.6 mm, the median bubble size (CDF equals 0.5) increases from 75 μm for nozzle 1 to 160 μm for nozzle 3 while at a shield height of 8.5 mm, the median size increases from 100 μm for nozzle 1 to 175 μm for nozzle 3. However, the clear trend shown in FIG. 6 should not be extrapolated to ever increasing nozzle diameters. The purpose of the constriction region is to provide a sudden decompression and when this constriction becomes too large to induce the necessary decompression, it is believed the mechanisms involved in bubble formation will change.

As shown in FIG. 6, nozzle 4 has an internal divergence region 405 at the outlet end of the channel 403 or pressure reducing constriction.

Bubble size distributions measured using nozzle 4 are plotted in FIG. 9 as a function of height above the nozzle exit. 701 represents a shield height of 0.6 mm, 702 a shield height of 3.2 mm, 703 a shield height of 4.8 mm and 704 with no shield.

The results in FIG. 9 indicate that relatively small bubbles having a narrow size distribution can be attained using nozzle 4 due to the presence of the convergence and divergence regions internal to the nozzle.

The influence of the divergence region is demonstrated by comparison of 704 in FIG. 9 with the data corresponding to the case of nozzle 2 (not shown) with no shield. The results strongly indicate that there is a substantial reduction in bubble size when a divergence region is present in the nozzle after the constriction. The results show a reduction in the median bubble size of more than 50%. FIG. 9 also shows that there is a reduction in bubble size as the height above the nozzle exit is reduced. The smallest bubbles were generated using nozzle 4 at a height of 0.6 mm above the nozzle exit with a resulting median bubble size of 50 μm.

In view of the above results, the preferred embodiment of the nozzle 301 comprises an internal convergence region 314 at the inlet 311 end of the channel or constriction 312 and a divergence region 315 at the outlet end 313 of the channel 312.

It was noted from the present research that the confinement of the nozzle outlet has a significant influence on the size of bubbles produced. In other words, as shown in FIG. 10, when tests were performed in a small flotation tank having a diameter of 125 mm, wherein the nozzle outlet was substantially confined, the CDF of bubble size produced was substantially smaller than for a relatively unconfined nozzle in, for example, a tank having a volume of 1 m³. In FIG. 10 plot 801 shows the data for bubbles produced in the 125 mm tank, whilst the plots labelled 802 indicate the bubble size produced in the 1 m³, repeated three times for consistency. Therefore, investigations were performed by the present invention to examine the effect of external shrouds to the CDF of bubbles produced.

Three different shroud configurations were examined to study the effect of an external shroud on the CDF of bubbles formed from a pressure reduction nozzle. The first shroud was a cylindrical shroud having parallel sides constructed from a section of Perspex™ tubing. The diameter d of the shroud was either d=40 or 60 mm, and the height H of the shroud was either H=20, 50, 80, 110 or 200 mm. In this sense, height means distance from the nozzle outlet. Experiments were performed with the base of the shroud flush to the nozzle (no gap) so as to prevent ambient liquid around the nozzle entering the end of the shroud closest to the nozzle outlet, or with a gap of h=10, 20 or 40 mm between the nozzle end of the shroud and the outlet of the nozzle, allowing the entrainment of ambient fluid into the nozzle end of the shroud.

Experiments were also performed with conical shrouds having a divergence angle θ of 30° or 40° and the height of the shroud being either h=20 or 50 mm. The conical shroud was flush against the nozzle outlet.

Further, experiments were also performed with a shroud having first and second portions of different diameters, as shown in FIG. 3. The first portion of the shroud closest to the nozzle outlet was a cylindrical tube, the nozzle end of which was flush against the nozzle outlet so as to prevent the entrainment of ambient fluid into the nozzle end of the shroud. The second shroud portion was a cylindrical tube having a larger diameter than the first shroud portion. Due to the different diameters of the first and second shroud portions, a lateral opening is present between first and second shroud portions. Ambient fluid is able to enter the shroud at the joint between the first and second shroud portions through the opening.

FIG. 11 shows the effect of varying a gap height between a single cylindrical shroud of height H=200 mm and diameter d=60 mm and the nozzle outlet. Plot 901 indicates the data for the case of no shroud, 902 indicates the data for h=40 mm, 903 indicates the case for h=20 mm, 904 indicates the data for the case of h=10 mm and 905 indicates the data for the case of h=0 mm.

As is clearly shown in FIG. 11, much smaller bubbles are produced from a nozzle assembly having a shroud present at the outlet of the nozzle with no gap between the nozzle outlet and the shroud. In other words, the nozzle outlet is in complete fluid communication with an end of the shroud sealed to ambient fluid around the assembly. However, as will be appreciated by the skilled person, embodiments of the present invention can be envisaged having one or more openings to allow ambient liquid to enter the shroud, either at the nozzle end of the shroud, such as between the nozzle and the shroud, or at an intermediate region of the shroud or first shroud portion.

FIG. 12 presents the data showing the effect of varying the shroud height or length H, in other words the longitudinal length of the shroud, for the case of a shroud with a diameter d=40 mm and no gap allowing the entrainment of ambient liquid between the nozzle and the shroud.

Plot 1001 indicates the data for the case of H=20 mm, 1002 indicates the data for the case of H=50 mm, 1003 indicates the data for the case of H=80 mm and 1004 indicates the data for the case of H=110 mm.

As can clearly be seen from FIG. 12, the bubbles generated with the shortest shroud (H=20 mm) are considerably larger than bubbles generated with the longer (H=50, 80, 110 mm) shrouds, which are all approximately comparable in size.

FIG. 13 presents the data for conical shrouds. 1101 indicates the data for the case of θ=40°, h=20 mm, 1102 indicates the data for the case of θ=30°, h=20 mm, 1103 indicates the data for the case of θ=40°, h=50 mm, 1104 indicates the data for the case of θ=30°, h=50 mm, 1105 indicates the data for the case of θ=30°, h=50 mm with a stainless steel impingement plate present in path of the nozzle outlet.

It can be noted from FIG. 13 that in all cases the resultant bubbles produced using a conical shroud were relatively large, as compared to the data in FIG. 12. It is thought that a conical shroud has a similar effect on bubble size as the shortest cylindrical shroud experiment presented in FIG. 12 for the case of H=20 mm.

FIG. 14 presents data showing the effect of the shroud diameter d on a cylindrical shroud, when there is no gap at the base of the shroud between the nozzle and the shroud and hence no entrainment of ambient liquid into the nozzle end of the shroud. 1201 indicates the data for the case of a shroud of diameter d=5 mm, 1202 indicates the data for the case of d=15 mm, 1203 indicates the data for the case of d=125 mm and 1204 indicates the data for the case of no shroud.

As can be appreciated from the data shown in FIG. 14, the shroud diameter strongly influences the size of bubbles produced. The peak in bubble size decreases from approximately 75 μm for the case of no shroud, to less than 40 μm for a shroud with d=5 mm.

Whilst FIG. 14 shows that a reduction in shroud diameter leads to a reduction in bubble size, it is believed that this trend does not continue indefinitely.

FIG. 15 presents data for an experiment performed with a shroud of diameter d=5 mm, indicated by reference numeral 1301, and data for a shroud of d=3 mm, indicated by a reference numeral 1302. Clearly, it can be observed that the bubbles generated for the d=3 mm shroud are larger than the bubbles generated with the d=5 mm shroud. It is believed that there is a minimum diameter of shroud below which macrobubble production begins to dominate microbubble production and for the experimental set up used, this lies between 3 and 5 mm. In these experiments, the diameter of the channel or constriction between the inlet and outlet of the nozzle was 1 mm. Therefore, an optimum relationship of 1:5 exists between the diameter of the nozzle constriction and the first shroud portion.

FIG. 16 presents the result of experiments performed using a shroud having first and second portions of different diameters. The experiments were all performed with a shroud having a cylindrical first portion of diameter d=5 mm and height h=40 mm.

Plot 1401 indicates the data for the case of a shroud not having a second portion, 1402 indicates the data for the case of a shroud having a second portion of d=25 mm and height h=40 mm, 1403 indicates data for the case of a shroud having a second portion of d=15 mm and height h=40 mm and 1404 indicates the data for a shroud having a second portion of diameter d=15 mm and height h=80 mm.

As can clearly be seen from FIG. 16, the geometry of the second shroud portion has little effect on the size of bubbles produced. Hence, the geometry of the second portion can be optimised to reduce a sheer hydrodynamic force between water entering the flotation tank form the nozzle and ambient liquid within the flotation tank in order to reduce floc-agglomerate fragmentation. In the preferred embodiment, the ratio of second shroud portion diameter to first shroud portion diameter is 2.6:1 and the second portion has approximately the same length as the second shroud portion.

When a fluid jet emerges from a nozzle into an ambient fluid, turbulent dissipation reduces a velocity of the jet until it becomes comparable to a velocity of the ambient fluid. It is believed that the rate of dissipation of the jet will be approximately constant for a distance of 5 nozzle diameters outward from the nozzle outlet, after which it will decrease as (d/z)⁴ where d represents the nozzle channel 312 diameter and z represents a distance outward or downstream from the nozzle outlet 313. Further, it is believed that after an abrupt expansion, such at the nozzle outlet into the first shroud portion 321, a fully developed jet is established downstream after 6 multiples of the first shroud portion diameter. Therefore, the length of the first shroud portion is at least 6 times its diameter in the preferred embodiment.

As described, the preferred embodiment provides a nozzle assembly comprising a nozzle and a shroud capable of producing bubbles within a flotation tank of a DAF system, the bubble having a median diameter of less than 50 μm. Such production of small bubbles increases the efficiency of the DAF system and allows the pressure at which a gas is saturated into a recycle stream to be reduced, thereby saving energy. The present invention may be operated at a pressure which provides bubbles equivalent in size to the prior art, whilst providing a significant energy consumption brought about by the reduced operating pressure required to produce a predetermined bubble size or operating efficiency. Tests have shown the present invention to provide a 30% reduction in energy consumption. Further, due to increased bubble-floc agglomeration the present invention allows 20% more ambient fluid to be treated and the treated ambient fluid has a lower turbidity.

The present invention, although not limited to, is suitable for use in a DAF system for purifying drinking water, waste water or other DAF system. Liquid or water to be purified is contained within the flotation tank and a recycle stream of gas saturated liquid such as water saturated with air is fed into the tank through a nozzle assembly. The gas may be an inert gas, oxygen or air.

The preferred embodiment of the present invention has been tested at various different pressures of recycle stream. Normally, a recycle stream of around 5 bar pressure is utilised. However, as shown in FIG. 17, the recycle stream pressure can be reduced to 3.5 bar using the preferred embodiment of the present invention without any significant change in the size of bubbles produced. Even operating at 2.5 bar pressure only a small increase in bubble size is observed. Therefore, use of the present invention allows recycle stream pressure to be reduced, thereby saving energy without substantially altering the effectiveness of the DAF process.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A nozzle assembly (300) for use in a dissolved gas flotation system, comprising:
a nozzle (310) having at least one inlet (311) and at least one outlet (313), the at least one inlet (311) and the at least one outlet (313) being in fluid communication; and
a shroud (320) comprising a first shroud portion (321), the shroud (320) being arranged, in use, to at least partly receive and confine a gas saturated fluid stream emitted from at least one nozzle outlet;
the nozzle assembly (300) being arrangeable in use within an ambient fluid, such that the gas saturated fluid stream forms bubbles within the ambient fluid;
characterised by:
the shroud (320) comprising at least one aperture (325) for, in use, allowing the ambient fluid to communicate with an interior of the shroud (320).

2. The nozzle assembly (300) according to claim 1, the at least one aperture (325) being arranged at an intermediate region of the shroud (320).

3. The nozzle assembly (300) according to claim 1, the at least one aperture (325) being arranged at an end region of the first shroud portion (321).

4. The nozzle assembly (300) according to claim 1, the shroud (320) comprising a second shroud portion (322) arranged, in use, to reduce a shear force between the fluid stream communicated to the first shroud portion (321) and the ambient fluid around the nozzle assembly (300).

5. The nozzle assembly (300) according to claim 4, the second shroud portion (322) being arranged to reduce a velocity of the fluid stream communicated from the first shroud portion (321).

6. The nozzle assembly (300) according to claim 4, the second shroud portion (322) being arranged to expand the fluid stream communicated from the first shroud portion (321).

7. The nozzle assembly (300) according to claim 4, the second shroud portion (322) being arranged at an end of the first shroud portion (321) distal from the at least one nozzle outlet.

8. The nozzle assembly (300) according to claim 4, the second shroud portion (322) having a cross sectional area generally larger than a cross sectional area of the first shroud portion (321).

9. The nozzle assembly (300) according to claim 4, wherein the at least one aperture (325) differentiates the first and second shroud portions.

10. The nozzle assembly (300) according to claim 1, the nozzle (310) having a constriction between the at least one inlet (311) and the at least one outlet (313), the constriction having a minimum width of d, the shroud (320) being arranged to substantially confine the fluid stream for a distance of at least 15 d.

11. The nozzle assembly (300) according to claim 10, the shroud (320) being arranged to substantially confine the fluid stream for a distance of at least 20 d.

12. The nozzle assembly (300) according to claim 10, the shroud (320) being arranged to substantially confine the fluid stream for a distance of at least 30 d.

13. The nozzle assembly (300) according to claim 10, the shroud (320) being arranged to substantially confine the fluid stream for a distance of at least 50 d.

14. The nozzle assembly (300) according to claim 10, the shroud (320) being arranged to substantially confine the fluid stream for a distance of at least 100 d.

15. The nozzle assembly (300) according to claim 14, the shroud (320) being arranged to substantially confine the fluid stream for a distance of at least 50 mm.

16. The nozzle assembly (300) according to claim 15, the shroud (320) being arranged to substantially confine the fluid stream for a distance of at least 60 mm.

17. The nozzle assembly (300) according to claim 16, the shroud (320) being arranged to substantially confine the fluid stream for a distance of at least 70 mm.

18. The nozzle assembly (300) according to claim 17, the shroud (320) being arranged to substantially confine the fluid stream for a distance of at least 80 mm.

19. The nozzle assembly (300) according to claim 18, the shroud (320) being arranged to substantially confine the fluid stream for a distance of at least 84 mm.

20. The nozzle assembly (300) according to claim 19, the shroud (320) being arranged to substantially confine the fluid stream for a distance of at least 90 mm.

21. The nozzle assembly (300) according to claim 20, the shroud (320) being arranged to substantially confine the fluid stream for a distance of at least 100 mm.

22. The nozzle assembly (300) according to claim 21, the shroud (320) being arranged to substantially confine the fluid stream for a distance of at least 110 mm.

23. The nozzle assembly (300) according to claim 22, the shroud (320) being arranged to substantially confine the fluid stream for a distance of at least 130 mm.

24. The nozzle assembly (300) according to claim 23, the shroud (320) being arranged to substantially confine the fluid stream for a distance of at least 150 mm.

25. The nozzle assembly (300) according to claim 24, the shroud (320) being arranged to substantially confine the fluid stream for a distance of at least 170 mm.

26. The nozzle assembly (300) according to claim 25, the shroud (320) being arranged to substantially confine the fluid stream for a distance of at least 200 mm.

27. The nozzle assembly (300) according to claim 1, the nozzle (310) having a constriction between the at least one inlet (311) and the at least one outlet (313), the constriction having a minimum width of d, the shroud (320) having a width of at least 2 d.

28. The nozzle assembly (300) according to claim 27, the shroud (320) having a width of at least 3 d.

29. The nozzle assembly (300) according to claim 27, the shroud (320) having a width of at least 4 d.

30. The nozzle assembly (300) according to claim 27, the shroud (320) having a width of 5 d.

31. The nozzle assembly (300) according to claim 27, the shroud (320) having a width of less than 6 d.

32. The nozzle assembly (300) according to claim 27 the shroud (320) having a width of less than 8 d.

33. The nozzle assembly (300) according to claim 27 the shroud (320) having a width of less than 10 d.

34. The nozzle assembly (300) according to claim 33, the shroud (320) having a width of at least 5 mm.

35. The nozzle assembly (300) according to claim 34, the shroud (320) having a width of at least 10 mm.

36. The nozzle assembly (300) according to claim 35, the shroud (320) having a width of 14 mm.

37. The nozzle assembly (300) according to claim 36, the shroud (320) having a width less than 16 mm.

38. The nozzle assembly (300) according to claim 37, the shroud (320) having a width less than 20 mm.

39. The nozzle assembly (300) according to claim 38, the shroud (320) having a width of less than 25 mm.

40. The nozzle assembly (300) according to claim 1, the shroud (320) having a general divergence of less than 30 degrees.

41. The nozzle assembly (300) according to claim 40, the shroud (320) having a general divergence of less than 20 degrees.

42. The nozzle assembly (300) according to claim 41, the shroud (320) having a general divergence of less than 10 degrees.

43. The nozzle assembly (300) according to claim 42, the shroud (320) having a general divergence of less than 5 degrees.

44. The nozzle assembly (300) defined in claim 1, wherein the bubbles formed within the ambient fluid have a median size of less than 50 μm.

45. (canceled)

46. A shroud as defined in claim 1.

47. A dissolved gas flotation system comprising:
at least one nozzle assembly (300) as defined in claim 1 arranged to receive, in use, a gas saturated fluid stream;
a tank for containing an ambient fluid;
wherein the at least one nozzle assembly (300) is arranged within the tank such that the gas saturated fluid stream forms bubbles within the ambient fluid.

48. The dissolved gas flotation system according to claim 47, comprising a plurality of nozzle assemblies.

49. The dissolved gas flotation system according to claim 47, wherein the ambient fluid is substantially water.

50. The dissolved gas flotation system according to claim 49, the ambient fluid is substantially drinking water.

51. The dissolved has flotation system according to claim 49, wherein the ambient fluid is substantially waste water.

52. The dissolved gas flotation system according to claim 47, wherein the nozzle assembly is arranged to receive a fluid stream substantially comprising water.

53. The dissolved gas flotation system according claim 47, wherein the nozzle assembly is arranged to receive a fluid stream saturated with an inert gas.

54. The dissolved gas flotation system according to claim 53, wherein the nozzle assembly is arranged to receive a fluid stream saturated with air.

55. The dissolved gas flotation system according to claim 53, wherein the nozzle assembly is arranged to receive a fluid stream saturated with oxygen.
